(19) United States
(12) Patent Application Publication
(10) Pub. No.: US 2008/0180470 A1
(43) Pub. Date: Jul. 31, 2008

(54) IMAGE FORMING APPARATUS AND METHOD OF TRANSFERRING PRINT DATA

(76) Inventor: Seiichiro OKU, Ashigarakami-gun (JP)

Correspondence Address: BIRCH STEWART KOLASCH & BIRCH, PO BOX 747, FALLS CHURCH, VA, 22040-0747, US

(21) Appl. No.: 12/022,610

(22) Filed: Jan. 30, 2008

(30) Foreign Application Priority Data
Jan. 31, 2007 (JP) 2007-021886

(51) Int. Cl. B41J 29/38

(52) U.S. Cl. 347/5

(57) ABSTRACT

An image forming apparatus includes: a rearrangement device having a configuration whereby the print data is rearranged in such a manner that data of pixels corresponding to mutually adjacent recording elements which are aligned on a straight line in the second direction in the recording head is located within a same word or within adjacent words; and an image buffer memory having at the least a storage capacity of storing the print data rearranged by the rearrangement device for an image region corresponding to a surface area occupied by a plurality of recording elements arranged in a two-dimensional matrix configuration in a recording head.

### BACKGROUND OF THE INVENTION

1. Field of the Invention

The present invention relates to an image forming apparatus and a method of transferring print data, and more particularly, to an image forming apparatus based on a dot recording method, such as an inkjet printer, and technology for efficiently transferring the print data used in such an apparatus.

2. Description of the Related Art

In the field of inkjet printers, a so-called matrix type of inkjet head in which nozzles are arranged in a two-dimensional array in order to eject ink droplets is well known. In a matrix type of head of this kind, it is necessary to make the interval between nozzles greater than the interval between pixels, due to the requirements of arrangements of the pressure chambers and the flow channels, and therefore the adjacency relationship between the nozzles which are mutually adjacent in the head and the pixels of the print dots which are mutually adjacent on the recording medium (on the image recorded on the recording paper) cannot be preserved directly. Consequently, an oblique matrix arrangement structure is adopted, in such a manner that the respective nozzles are arranged in slightly staggered positions (see FIGS. 15A and 15B).

FIGS. 15A and 15B are diagrams showing schematic illustrations of the alignment of the pixels of image data (bit map) and the alignment positions of the nozzles in a matrix type head. The vertical direction (the direction from above to below) in FIG. 15A represents the conveyance direction of the recording medium (paper), and the respective cells in FIG. 15A represent the positions of the pixels which make up the image. The arrangement pitch in the vertical direction between the cells in the bit map depicted in FIG. 15A represents the printed image resolution (recording resolution) in the conveyance direction of the paper, and the arrangement pitch between the cells in the lateral direction represents the image resolution in the breadthways direction of the paper.

In FIG. 15A, the region surrounded by the dotted square shape indicated by reference numeral 200 corresponds to the region of the matrix head, and the positions of the cells which are filled with black in FIG. 15A represent the positions of the nozzles in the matrix head. For the purpose of the illustration, the nozzles are depicted at intervals of every four pixels in the vertical direction and at intervals of every 6 pixels in the lateral direction, but in an actual head, the nozzles are spaced at a greater pixel interval apart (for example, at an interval of approximately 50 pixels apart). FIG. 15B shows a schematic view of the region of a two-dimensional matrix arrangement of the nozzles in the matrix type head, and in this depiction, the nozzle numbers 1 to 24 are assigned to the respective nozzle positions.

When using a matrix type head of this kind to print a desired image (for example, the bitmap image shown in FIG. 15A), the print data generated previously in the memory is read out and transferred to the matrix type head, and the head is driven so as to eject ink droplets from the corresponding nozzles in the head. However, in this case, there are possibilities of the following kinds.

(1) The print data for nozzles which are mutually adjacent and aligned on a straight line in the main scanning direction in the head corresponds to discrete positions in the image page memory (see FIGS. 15A and 15B).
(2) In particular, in an actual matrix type head, the nozzles are separated by several 10 pixels to several 100 pixels from each other, and furthermore, the width of the whole head (the width in the conveyance direction of the paper) corresponds to 1000 lines (1000 pixels) or greater. Consequently, the print data for all of the nozzles of the head for each droplet ejection action (the data for one droplet ejection) must be gathered from the broad image region which is occupied by the head (the range of the broad image region is demarcated by the dotted line 200 in FIG. 15A). A memory of large capacity, such as the image page memory, is generally constituted by a DRAM (dynamic RAM), but one characteristic of a DRAM is that access to non-consecutive addresses of this kind is slow (a small fraction or less of the access speed for consecutive addresses).
(3) The image page memory is normally constituted in units of words (e.g., 8 bit, 16 bit, 32 bit), and data is read out in word units, but if the print data is 1 to 2-bit data for each nozzle (in the case of an inkjet printer, it is often the case that droplet ejection can be modulated in 1 to 3 stages at the most, for each nozzle), then since the data for mutually adjacent nozzles is not included in the same word, as described previously, it is necessary to read out one word and then discard the remainder in order to read out one bit, and therefore the memory reading efficiency is poor (see FIG. 16).

FIG. 16 shows an example in which one word is constituted by four bits (four cell units enclosed by a thick line). Print data is read out from and written to the memory which stores the data in word units (4-bit units), but the print data which actually contributes to the driving of the nozzles (ink ejection) is only one bit of that one word.

(4) The fact that the read-out addresses from the memory are dispersed in a scattered fashion (random read-out) and that the read-out efficiency is poor does not pose a significant problem when the speed of the printer is slow (e.g., if the head has a small number of nozzles, or if the driving frequency of the head is low), but if high-speed characteristics are required in the printing apparatus, for instance, if the apparatus is constituted so as to print at high speed by means of a full line type of head having the width of a page, then the memory read-out speed and data transfer speed do present an obstacle to achieving high-speed performance.
(5) Furthermore, even in the case of a low-speed printer which can be achieved by means of a current method, supposing that the memory access can be made yet more efficient, it is possible to compose a system by means of a relatively slow (and inexpensive) memory, and consequently further cost reductions can be expected.

Japanese Patent Application Publication No. 2006-44150 discloses a composition in which, in order to achieve high-speed printing in an inkjet printing apparatus in which the nozzle rows are arranged in an oblique fashion, a shift register of variable length in accordance with the position of the nozzle is used for each nozzle. Furthermore, in Japanese Patent Application Publication No. 2006-44150, it is sought to reduce the capacity of the shift register, by dividing the shift register into a plurality of groups and controlling them.

In the case of an oblique nozzle arrangement as disclosed in Japanese Patent Application Publication No. 2006-44150, it is possible to adopt a composition based on a shift register because the interval between nozzles is approximately several pixels, but in the case of a matrix type of head, since the intervals between the nozzles are large (several tens of pixels or greater), then it is necessary to prepare a shift register of large volume which can be accessed at high speed, and this is not practicable.

Furthermore, in Japanese Patent Application Publication No. 2006-44150, it is stated that “the aforementioned problem can be resolved by aligning the horizontal print data in accordance with the nozzle arrangement in a higher-level apparatus and then rearranging the data arrangement according to the ejection sequence of the nozzles, but the rearranging process described above is problematic in that it cannot keep pace with increase in the printing speed of the inkjet printing apparatus”.

### SUMMARY OF THE INVENTION

The present invention has been contrived in view of these circumstances, an object thereof being to provide an image forming apparatus which is capable of achieving high-speed transfer of print data to the recording head at low cost, and to a method of transferring print data used in such an apparatus.

An aspect of the invention is an image forming apparatus comprising: a recording head including a plurality of recording elements which are arranged in a two-dimensional matrix configuration and are driven in accordance with print data while a recording medium is moved relatively with respect to the recording head in a first direction so that dots are recorded onto the recording medium to form an image on the recording medium; a line memory which stores the print data for one line aligned in a second direction that is perpendicular to the first direction, of the print data for one page; a rearrangement device which rearranges alignment sequence of the print data for one line stored in the line memory; an image buffer memory which stores the print data which has been rearranged by the rearrangement device; and a transfer device which reads out the print data from the image buffer memory and transfers the print data read out from the image buffer memory to the recording head, wherein the rearrangement device has a configuration whereby the print data is rearranged in such a manner that data of pixels corresponding to mutually adjacent recording elements which are aligned on a straight line in the second direction in the recording head is located within a same word or within adjacent words, and the image buffer memory has at the least a storage capacity of storing the print data rearranged by the rearrangement device for an image region corresponding to a surface area occupied by the plurality of recording elements arranged in the two-dimensional matrix configuration in the recording head.

Desirably, the image buffer memory is constituted by a dynamic random-access memory (DRAM).

Desirably, the image forming apparatus further comprises a post-processing calculation device of carrying out correctional processing of the print data in the image buffer memory.

Desirably, the correctional processing is a masking process which prohibits recording of a dot onto the recording medium by a specific recording element of the recording elements.

Another aspect of the invention is a method of transferring print data in an image forming apparatus which has a recording head including a plurality of recording elements which are arranged in a two-dimensional matrix configuration and are driven in accordance with print data while a recording medium is moved relatively with respect to the recording head in a first direction so that dots are recorded onto the recording medium to form an image on the recording medium, the method of transferring print data comprising: a line memory storing step of storing, in a line memory, the print data for one line aligned in a second direction that is perpendicular to the first direction, of the print data for one page; a rearrangement step of rearranging alignment sequence of the print data for one line stored in the line memory; a buffer memory storage step of storing, in an image buffer memory, the print data which has been rearranged in the rearrangement step; and a transfer step of reading out the print data from the image buffer memory and transferring the read-out print data to the recording head, wherein in the rearrangement step, the print data is rearranged in such a manner that data of pixels corresponding to mutually adjacent recording elements which are aligned on a straight line along the second direction in the recording head is located within a same word or within adjacent words, and the image buffer memory has at the least a storage capacity of storing the rearranged print data for an image region corresponding to a surface area occupied by the plurality of recording elements arranged in the two-dimensional matrix configuration in the recording head.

According to the above-described aspects of an image forming apparatus and a method of transferring print data used in same according to the present invention, the data corresponding to mutually adjacent recording elements of a matrix type head in the image buffer memory is rearranged so as to be stored at consecutive addresses, in accordance with the adjacency relationships in the arrangement of recording elements in the matrix type head; therefore when print data is read out from the image buffer memory and transferred to the head, the memory reading efficiency is good and high-speed data reading and high-speed data transfer can be achieved.

Furthermore, it is possible to adopt a composition in which the storage device (image page memory) which stores the print data for one page is provided in the image forming apparatus, or a composition in which this storage device is provided in a host computer that is connected to the image forming apparatus via a communications interface.

If the image page memory is provided in the host computer, then a desirable mode is one where a communications buffer memory is provided in the image forming apparatus.

According to the above-described aspects of the present invention, since the read-out of print data from the memory is efficient, then the image page memory can be located in the host computer and data read-out from this image page memory can be carried out via the communications interface of the host computer (for example, USB, IEEE 1394, or the like). In this case, there is no need to provide an image page memory for one page in the printer, and therefore costs can be reduced yet further.

An inkjet recording apparatus according to one mode of an image forming apparatus according to the present invention comprises: a liquid ejection head (corresponding to a “recording head”) having a liquid droplet ejection element row in which a plurality of liquid droplet ejection elements (corresponding to “recording elements”) are arranged in a row, each liquid droplet ejection element comprising a nozzle for ejecting an ink droplet in order to form a dot and a pressure generating device (piezoelectric element, heating element, or the like) which generates an ejection pressure; and an ejection control device which controls the ejection of liquid droplets from the recording head on the basis of ink ejection data generated from the image data. An image is formed on a recording medium by means of the liquid droplets ejected from the nozzles.

A compositional example of the recording head is a full line type of head having a recording element row in which a plurality of recording elements are arranged through a length corresponding to the full width of the recording medium. In this case, a mode may be adopted in which a plurality of relatively short recording head modules having recording element rows each of which does not reach a length corresponding to the full width of the recording medium are combined and joined together, thereby forming a recording element row of a length that correspond to the full width of the recording medium as a whole.

If a full line head having a page-wide printing width is composed by means of a matrix type head, then the relative conveyance direction of the recording medium with respect to the head corresponds to the sub-scanning direction (the “first direction”). Consequently, if a two-dimensional matrix arrangement of a plurality of recording elements is projected (orthogonally) to a straight line aligned in the second direction (main scanning direction), then the projected recording elements are arranged in alignment in the second direction.

A full line type (page-wide) head is usually disposed in a direction that is perpendicular to the relative feed direction (relative conveyance direction) of the recording medium, but a mode may also be adopted in which the recording head is disposed following an oblique direction that forms a prescribed angle with respect to the direction perpendicular to the conveyance direction.

The “recording medium” indicates a medium on which an image is recorded by means of the action of the recording head (this medium may also be called an image forming medium, recording medium, image receiving medium or, in the case of an inkjet printer, an ejection medium or ejection receiving medium, or the like). This term includes various types of media, irrespective of material and size, such as continuous paper, cut paper, sealed paper, resin sheets such as OHP sheets, film, cloth, an intermediate transfer body, a printed circuit board on which a wiring pattern, or the like, is printed by means of an inkjet recording apparatus, and the like.

The device for causing the recording medium to move relatively with respect to the recording head may include: a mode where the recording medium is conveyed with respect to the stationary (fixed) recording head; a mode where the recording head is moved with respect to the stationary recording medium; and a mode where both the recording head and the recording medium are moved.

When forming color images by means of an inkjet head, it is possible to provide recording heads according to colors of a plurality of colored inks (recording liquids), or it is possible to eject inks of a plurality of colors, from one recording head.

Furthermore, the present invention is not limited to a full line type of head as described above, and it may also be applied to a system which performs recording by moving a short recording head a plurality of times.

According to the present invention, since print data can be read out efficiently from the consecutive addresses from the image buffer memory, then high-speed read-out and the high-speed transfer can be achieved. Furthermore, since the memory can be composed readily by means of an inexpensive DRAM, then it is possible to reduce costs.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a general schematic drawing of an inkjet recording apparatus which forms one embodiment of an image forming apparatus relating to the present invention;

FIGS. 2A and 2B are plan view perspective diagrams showing an example of the composition of a print head;

FIG. 3 is a plan view perspective diagram showing a further example of the composition of a full line head;

FIG. 4 is a cross-sectional view along line 4-4 in FIGS. 2A and 2B;

FIG. 5 is an illustrative diagram showing the concept of virtual nozzles, in an enlarged view of the nozzle arrangement in the head illustrated in FIG. 2A;

FIG. 6 is a principal block diagram showing the system configuration of an inkjet recording apparatus according to an embodiment of the present invention;

FIG. 7 is a diagram showing an example (1) of the composition of a rearrangement unit;

FIG. 8 is a diagram showing a further example (2) of the composition of the rearrangement unit;

FIG. 9 is a diagram showing a further example (3) of the composition of the rearrangement unit;

FIG. 10 is a diagram showing an example of print data for one page which is stored in an image page memory;

FIG. 11 is an illustrative diagram showing a method of writing print data to the image buffer memory and of reading data from the image buffer memory;

FIG. 12 is an illustrative diagram showing the flow of print data in a composition where an image page memory is provided inside the printer;

FIG. 13 is an illustrative diagram showing a masking process as an example of processing carried out in a post-processing calculation unit;

FIG. 14 is an illustrative diagram showing the flow of print data in a composition where an image page memory is not provided inside the printer;

FIGS. 15A and 15B are diagrams showing a schematic view of the relationship between the arrangement of pixels of image data and the nozzle positions in a matrix type head; and

FIG. 16 is an illustrative diagram showing a method of reading out print data in the related art.

### DETAILED DESCRIPTION OF THE PREFERRED EMBODIMENTS

### Example of Application to Inkjet Recording Apparatus

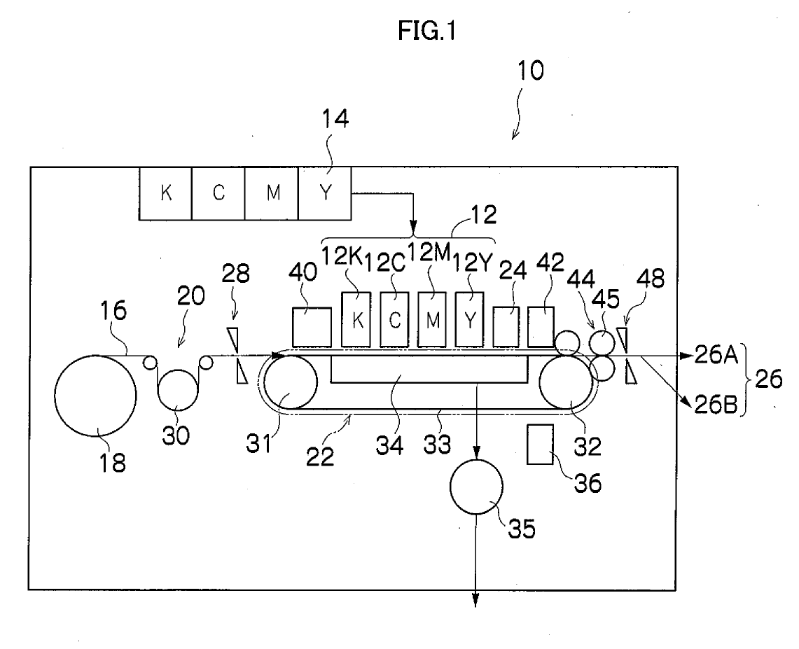

FIG. 1 is a general configuration diagram of an inkjet recording apparatus showing an image forming apparatus according to an embodiment of the present invention. As shown in FIG. 1, the inkjet recording apparatus 10 comprises: a print unit 12 having a plurality of inkjet recording heads (hereafter, called “heads”) 12K, 12C, 12M, and 12Y provided for ink colors of black (K), cyan (C), magenta (M), and yellow (Y), respectively; an ink storing and loading unit 14 for storing inks of K, C, M and Y to be supplied to the print heads 12K, 12C, 12M, and 12Y, a paper supply unit 18 for supplying recording paper 16 which is a recording medium; a decurling unit 20 removing curl in the recording paper 16; a belt conveyance unit 22 disposed facing the nozzle face (ink-droplet ejection face) of the print unit 12, for conveying the recording paper 16 while keeping the recording paper 16 flat; a print determination unit 24 for reading the printed result produced by the print unit 12; and a paper output unit 26 for outputting the image-printed recording paper (printed matter) to the exterior.

The ink storing and loading unit 14 has ink tanks for storing the inks of K, C, M and Y to be supplied to the heads 12K, 12C, 12M, and 12Y, and the tanks are connected to the heads 12K, 12C, 12M, and 12Y by means of prescribed channels. The ink storing and loading unit 14 has a warning device (for example, a display device or an alarm sound generator) for warning when the remaining amount of any ink is low, and has a mechanism for preventing loading errors among the colors.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording medium (medium) can be used, it is preferable that an information recording medium such as a bar code and a wireless tag containing information about the type of medium is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

In the case of the configuration in which roll paper is used, a cutter (first cutter) 28 is provided as shown in FIG. 1, and the continuous paper is cut into a desired size by the cutter 28.

The decurled and cut recording paper 16 is delivered to the belt conveyance unit 22. The belt conveyance unit 22 has a configuration in which an endless belt 33 is set around rollers 31 and 32 so that the portion of the endless belt 33 facing at least the nozzle face of the print unit 12 and the sensor face of the print determination unit 24 forms a horizontal plane (flat plane).

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the print unit 12 on the interior side of the belt 33, which is set around the rollers 31 and 32, as shown in FIG. 1. The suction chamber 34 provides suction with a fan 35 to generate a negative pressure, and the recording paper 16 is held on the belt 33 by suction. It is also possible to use an electrostatic attraction method, instead of a suction-based attraction method.

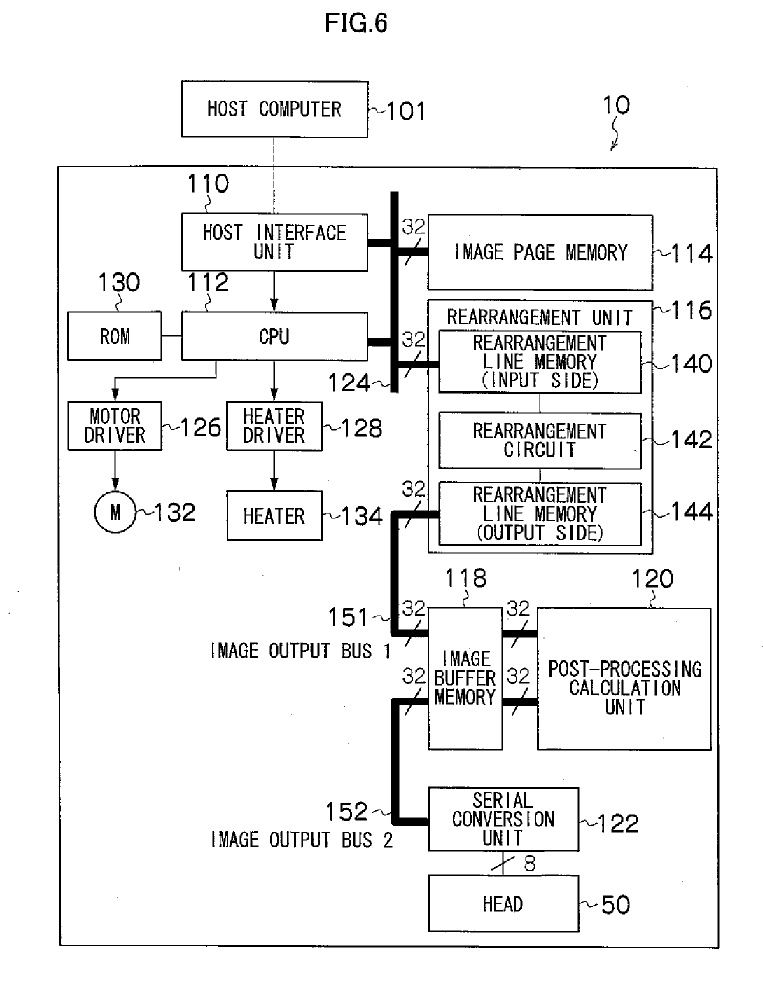

The belt 33 is driven in the clockwise direction in FIG. 1 by the motive force of a motor 132 (not shown in FIG. 1, but shown in FIG. 6) being transmitted to at least one of the rollers 31 and 32, around which the belt 33 is set, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration in which the belt 33 is nipped with cleaning rollers such as a brush roller and a water absorbent roller, an air blow configuration in which clean air is blown onto the belt 33, and a combination of these.

Instead of the belt conveyance unit 22, it might also be possible to use a roller nip conveyance mechanism, but since the print region passes through the roller nip, the printed surface of the paper makes contact with the rollers immediately after printing, and hence smearing of the image is liable to occur. Therefore it is desirable to adopt suction belt conveyance which does not make contact with the image surface in the printing region.

A heating fan 40 is disposed on the upstream side of the print unit 12 in the conveyance pathway formed by the belt conveyance unit 22. The heating fan 40 blows heated air onto the recording paper 16 to heat the recording paper 16 immediately before printing so that the ink deposited on the recording paper 16 dries more easily.

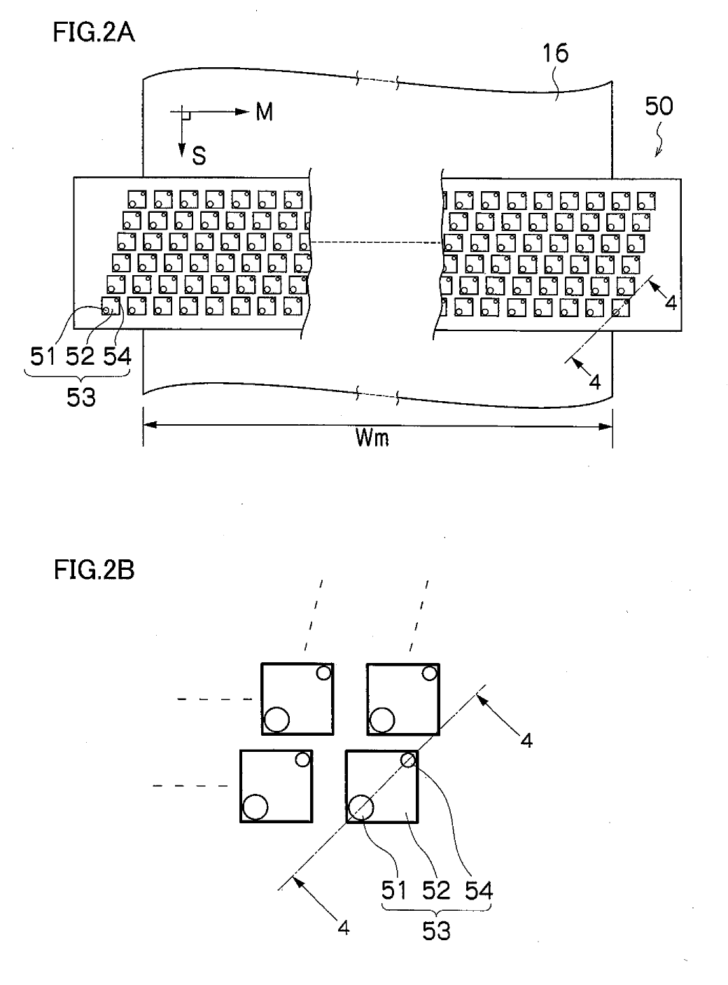

The heads 12K, 12C, 12M and 12Y of the print unit 12 are full line heads having a length corresponding to the maximum width of the recording paper 116 used with the inkjet recording apparatus 10, and comprising a plurality of nozzles for ejecting ink arranged on a nozzle face through a length exceeding at least one edge of the maximum-size recording medium (namely, the full width of the printable range) (see FIGS. 2A and 2B).

The print heads 12K, 12C, 12M and 12Y are arranged in color order (black (K), cyan (C), magenta (M), yellow (Y)) from the upstream side in the feed direction of the recording paper 16, and these respective heads 12K, 12C, 12M and 12Y are fixed extending in a direction substantially perpendicular to the conveyance direction of the recording paper 16.

A color image can be formed on the recording paper 16 by ejecting inks of different colors from the heads 12K, 12C, 12M and 12Y, respectively, onto the recording paper 16 while the recording paper 16 is conveyed by the belt conveyance unit 22.

By adopting a configuration in which the full line heads 12K, 12C, 12M and 12Y having nozzle rows covering the full paper width are provided for the respective colors in this way, it is possible to record an image on the full surface of the recording paper 16 by performing just one operation of relatively moving the recording paper 16 and the print unit 12 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

The print determination unit 24 shown in FIG. 1 has an image sensor for capturing an image of the ink-droplet deposition result of the print unit 12, and functions as a device to check for ejection characteristics such as clogs, landing position error, and the like, of the nozzles in the print unit 12 from the ink-droplet deposition results evaluated by the image sensor.

A CCD area sensor in which a plurality of photoreceptor elements (photoelectric transducers) are arranged two-dimensionally on the light receiving surface is suitable for use as the print determination unit 24 of the present example. An area sensor has an imaging range which is capable of capturing an image of at least the full area of the ink ejection width (image recording width) of the respective heads 12K, 12C, 12M and 12Y. It is possible to achieve the required imaging range by means of one area sensor, or alternatively, it is also possible to ensure the required imaging range by combining (joining) together a plurality of area sensors. Alternatively, a composition may be adopted in which the area sensor is supported on a movement mechanism (not illustrated), and an image of the required imaging range is captured by moving (scanning) the area sensor.

Furthermore, it is also possible to use a line sensor instead of the area sensor. In this case, a desirable composition is one in which the line sensor has rows of photoreceptor elements (rows of photoelectric transducing elements) with a width that is greater than the ink droplet ejection width (image recording width) of the print heads 12K, 12C, 12M and 12Y.

A test pattern or the target image printed by the print heads 12K, 12C, 12M, and 12Y of the respective colors is read in by the print determination unit 24, and the ejection performed by each head is determined. The ejection determination includes detection of the ejection, measurement of the dot size (volume of ejected liquid droplets), and measurement of the dot formation position.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. Although not shown in FIG. 1, the paper output unit 26A for the target prints is provided with a sorter for collecting prints according to print orders.

### Structure of the Head

Next, the structure of a head will be described. The heads 12K, 12C, 12M and 12Y of the respective ink colors have the same structure, and a reference numeral 50 is hereinafter designated to any of the heads.

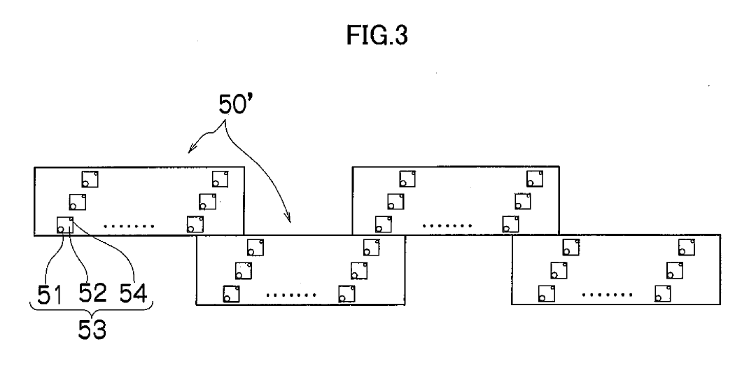

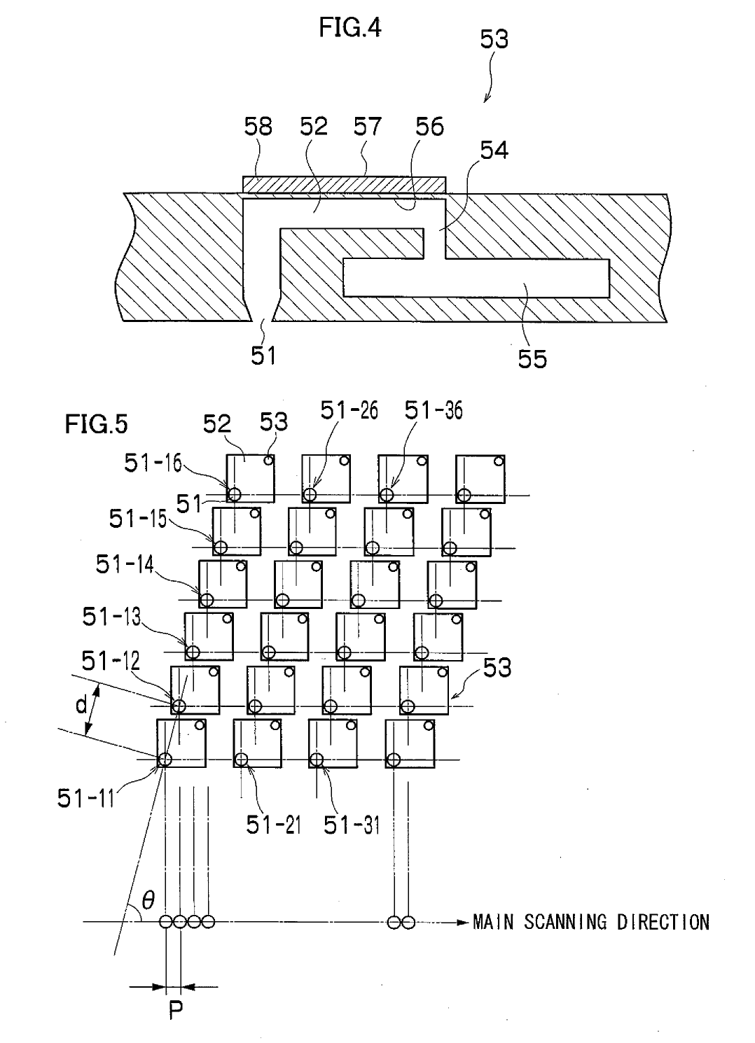

FIG. 2A is a perspective plan view showing an example of the configuration of the head 50, FIG. 2B is an enlarged view of a portion thereof, FIG. 3 is a perspective plan view showing another example of the configuration of the head 50, and FIG. 4 is a cross-sectional view taken along the line 4-4 in FIGS. 2A and 2B, showing the structure of a droplet ejection element (an ink chamber unit for one nozzle 51) for one channel that can be a recording element unit.

The nozzle pitch in the head 50 should be minimized in order to maximize the density of the dots printed on the surface of the recording paper 16. As shown in FIGS. 2A and 2B, the head 50 according to the present embodiment has a structure in which a plurality of ink chamber units (droplet ejection elements) 53, each comprising a nozzle 51 forming an ink ejection port, a pressure chamber 52 corresponding to the nozzle 51, and the like, are disposed two-dimensionally in the form of a staggered matrix, and hence the effective nozzle interval (the projected nozzle pitch) as projected (orthogonal projection) in the lengthwise direction of the head (the direction perpendicular to the paper conveyance direction) is reduced and high nozzle density is achieved.

The mode of forming one or more nozzle rows with a length corresponding to the entire width Wm of the recording paper 16 in a direction (the direction of arrow M: main-scanning direction) substantially perpendicular to the conveyance direction (the direction of arrow S: sub-scanning direction) of the recording paper 16 is not limited to the example described above. For example, instead of the configuration in FIG. 2A, as shown in FIG. 3, a line head having nozzle rows of a length corresponding to the entire width of the recording paper 16 can be formed by arranging and combining, in a staggered matrix, short head modules 50, having a plurality of nozzles 51 arrayed in a two-dimensional fashion.

As shown in FIGS. 2A and 2B, the planar shape of the pressure chamber 52 provided for each nozzle 51 is substantially a square, and an outlet to the nozzle 51 is disposed in one of corner on a diagonal line of the square and an inlet of supplied ink (supply port) 54 is disposed in the other corner. The shape of the pressure chamber 52 is not limited to that of the present example and various modes are possible in which the planar shape is a quadrilateral shape (diamond shape, rectangular shape, or the like), a pentagonal shape, a hexagonal shape, or other polygonal shape, or a circular shape, elliptical shape, or the like.

As shown in FIG. 4, each pressure chamber 52 is connected to a common channel 55 through the supply port 54. The common channel 55 is connected to an ink tank (not shown), which is a base tank that supplies ink, and the ink supplied from the ink tank is delivered through the common flow channel 55 to the pressure chambers 52.

An actuator 58 provided with an individual electrode 57 is bonded to a pressure plate 56 (a diaphragm that also serves as a common electrode) which forms the surface of one portion (the ceiling in FIG. 4) of the pressure chamber 52. When a drive voltage is applied to the individual electrode 57 and the common electrode, the actuator 58 is deformed, the volume of the pressure chamber 52 is thereby changed, and the pressure in the pressure chamber 52 is thereby changed, so that the ink inside the pressure chamber 52 is thus ejected through the nozzle 51. For the actuators 58, it is possible to adopt a piezoelectric element using a piezoelectric body, such as lead zirconate titanate, barium titanate, or the like. When the displacement of the actuator 58 returns to its original position after ejecting ink, the pressure chamber 55 is replenished with new ink from the common flow channel 54, via the supply port 52.

By controlling the driving of the actuators 58 corresponding to the nozzles 51 in accordance with the dot arrangement data generated from the input image, it is possible to eject ink droplets from the nozzles 51. By controlling the ink ejection timing from the nozzles 51 in accordance with the speed of conveyance of the recording paper 16 while conveying the recording paper 16 in the sub-scanning direction at a uniform speed, it is possible to record a desired image onto the recording paper 16.

As shown in FIG. 5, the high-density nozzle head according to the present embodiment is achieved by arranging a plurality of ink chamber units 53 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of θ with respect to the main scanning direction, the pitch P of the nozzles projected so as to align in the main scanning direction is d×cos θ, and hence the nozzles 51 can be regarded substantially to be equivalent to those arranged linearly at a fixed pitch P along the main scanning direction. Such configuration results in a nozzle structure in which the nozzle row projected in the main scanning direction has a high nozzle density of up to 2,400 nozzles per inch.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 51 arranged in a matrix such as that shown in FIG. 5 are driven, the main scanning according to the above-described (3) is preferred. More specifically, the nozzles 51-11, 51-12, 51-13, 51-14, 51-15 and 51-16 are treated as a block (additionally; the nozzles 51-21, 51-22, . . . , 51-26 are treated as another block; the nozzles 51-31, 51-32, . . . , 51-36 are treated as another block; . . . ); and one line is printed in the width direction of the recording paper 16 by sequentially driving the nozzles 51-11, 51-12, . . . , 51-16 in accordance with the conveyance velocity of the recording paper 16.

On the other hand, “sub-scanning” is defined as to repeatedly perform printing of one line (a line formed of a row of dots, or a line formed of a plurality of rows of dots) formed by the main scanning, while moving the full-line head and the recording paper relatively to each other.

The direction indicated by one line (or the lengthwise direction of a band-shaped region) recorded by the main scanning as described above is called the “main scanning direction”, and the direction in which sub-scanning is performed, is called the “sub-scanning direction”. In other words, in the present embodiment, the conveyance direction of the recording paper 16 is called the sub-scanning direction and the direction perpendicular to same is called the main scanning direction.

In implementing the present embodiment, the arrangement of the nozzles is not limited to that of the example illustrated. Moreover, a method is employed in the present embodiment where ink droplets are ejected by means of the deformation of the actuators 58, which is typically made from a piezoelectric element; however, in implementing the present embodiment, the method used for discharging ink is not limited in particular, and instead of the piezo jet method, it is also possible to apply various types of methods, such as a thermal jet method where the ink is heated and bubbles are caused to form therein by means of a heat generating body such as a heater, ink droplets being ejected by means of the pressure applied by these bubbles.

### Description of Control System

FIG. 6 is a block diagram showing the system composition of the inkjet recording apparatus 10. FIG. 6 shows only the portion which relates principally to image data processing. As shown in FIG. 6, the inkjet recording apparatus 10 according to the present example comprises an interface unit (host interface unit) 110 for performing communications with a host computer 101, a central processing apparatus (CPU) 112, an image page memory 114, a rearrangement unit 116, an image buffer memory 118, a post-processing calculation unit 120, a serial conversion unit 122, and the like.

The host interface unit 110 is a communications interface unit (image input unit) which functions as an image input device for receiving image data transmitted from the host computer 101 and is connected to the CPU 112 via a CPU Bus 124. For this host interface unit 110, a serial interface such as USB (Universal Serial Bus), IEEE 1394, Ethernet (registered trademark), wireless network, or a parallel interface such as a Centronics interface may be used. A buffer memory (not shown) may be mounted in this portion in order to increase the communication speed.

The CPU 112 functions as a control device for controlling the whole of the inkjet recording apparatus 10 in accordance with a prescribed program, as well as a calculation device for performing various calculations. More specifically, the CPU 112 controls the various sections, such as the host interface unit 110, motor driver 126, heater driver 128, and the like, as well as controlling communications with the host computer 101 and writing and reading to and from the image memory 114 and ROM 130, and it also generates control signals for controlling the motor 132 of the conveyance system and the heater 134.

The ROM 130 stores programs to be executed by the CPU 112, and various data required for control operations (including data for a test pattern for determining nozzle characteristics), and the like. The ROM 130 may be a non-rewriteable storage device, but if the various types of data are updated as and when necessary, then desirably, a rewriteable storage device such as an EEPROM is used.

The motor driver (drive circuit) 126 drives the motor 132 of the conveyance system in accordance with commands from the CPU 112. The heater driver (drive circuit) 128 drives the heater 134 of the post-drying unit 42 (see FIG. 1) and the like in accordance with commands from the CPU 112.

The image page memory 114 is a storage device for storing an image input via the host interface unit 110, and it has a storage capacity sufficient for storing the image data for one page (for example, several hundred MB to 1 GB). A DRAM (dynamic random-access memory) is used as the image page memory 114 according to the present embodiment. The image page memory 114 is connected to the CPU bus 124, and data is read and written via the CPU 112. This image page memory 114 is used as a temporary storage extent for the image data for printing, and is also used as a region for expanding the program implemented by the CPU 112 and as a calculation work region for the CPU 112. In order to achieve more efficient access, this image page memory 114 is constituted by units (words) each of which has a width of 32 bits, for example.

The rearrangement unit 116 includes an input-side line memory 140, a rearrangement circuit 142, and an output-side line memory 144.

The input-side line memory 140 is connected to the image page memory 114 via the CPU bus 124. On the other hand, the output-side line memory 144 is connected to the image buffer memory 118 via the first image output bus 151.

The details of the processing in the rearrangement unit 116 are described below, but in this rearrangement unit 116, the data rows are rearranged in such a manner that the data for mutually adjacent nozzles which are aligned in a line in the main scanning direction of the head is disposed within the same word or in mutually adjacent words. The data for one line which has been rearranged is transferred from the output-side line memory 144 to the image buffer memory 118, and this data for one line is stored at consecutive addresses in the image buffer memory 118.

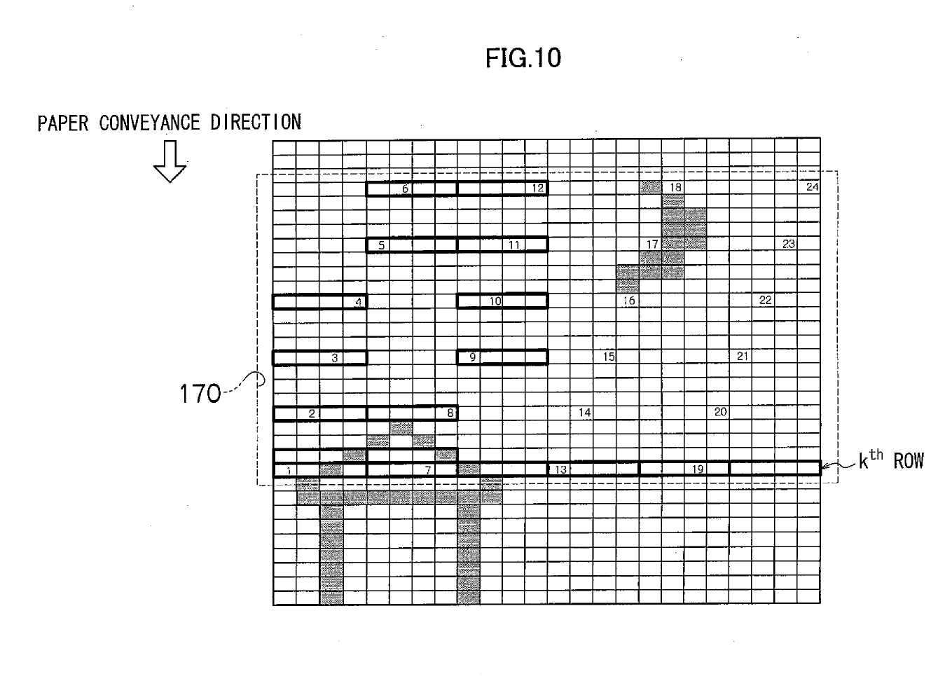

The image buffer memory 118 according to the present embodiment is constituted by a DRAM, and has a capacity for storing at least the data of an image region corresponding to the surface area occupied by the two-dimensional matrix arrangement of nozzles in the head 50 (this is equivalent to the region enclosed by the dotted line and indicated by reference numeral 170 in FIG. 10 described hereinafter). Print data for a plurality of lines corresponding to the surface area occupied by the head is accumulated in the image buffer memory 118.

The post-processing calculation unit 120 is a calculation device which carries out processing, such as a masking process in respect of abnormal nozzles (processing for prohibiting droplet ejection) and shading correction (processing for raising or lowering the droplet ejection rate for each nozzle) and the like, in the image buffer memory 118. Prescribed post-processing is carried out by the post-processing calculation unit 120 on the print data stored in the image buffer memory 118, and the processed data is then written back to the image buffer memory 118.

The image buffer memory 118 is connected to the serial conversion unit 122 via a second image output bus 152. The print data for one droplet ejection action (for all of the nozzles) is read out from the image buffer memory 118, and is transferred to the head 50 via the serial conversion unit 122. By transferring the print data to the head 50 via the serial conversion unit 122, it is possible to reduce the number of signal lines leading to the head 50.

By supplying print data which corresponds to the print contents to the head 50 in this way, the driving of the actuators 58 which correspond to the nozzles 51 of the head 50 is controlled and ink is ejected from the corresponding nozzles 51. By controlling ink ejection from the heads 50 in synchronization with the conveyance velocity of the recording paper 16, an image is formed on the recording paper 16.

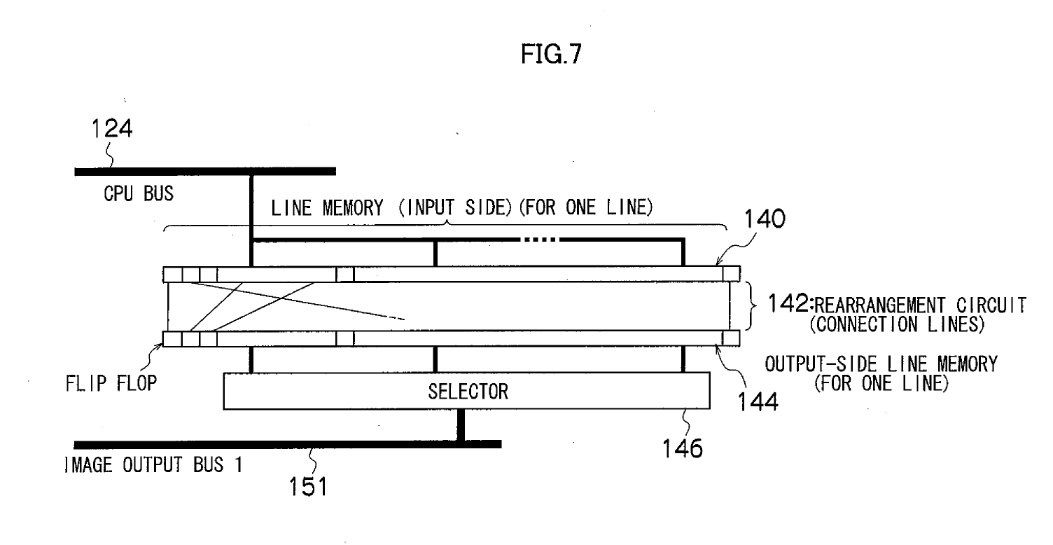

FIG. 7 shows an example of the structure of the rearrangement unit 116. The input-side line memory 140 and the output-side line memory 144 is constituted by so-called registers (flip flops). Furthermore, the rearrangement circuit 142 is, for example, constituted by a circuit which designates the connections (connection lines) between the output terminal of each flip-flop in the input-side line memory 140 and the input terminal of each flip-flop in the output-side line memory 144. The output terminal of the output-side line memory 144 is connected to the image output bus 151 via a selector 146. By appropriately changing the connection mode of the rearrangement circuit 142, it is possible to achieve a prescribed rearrangement.

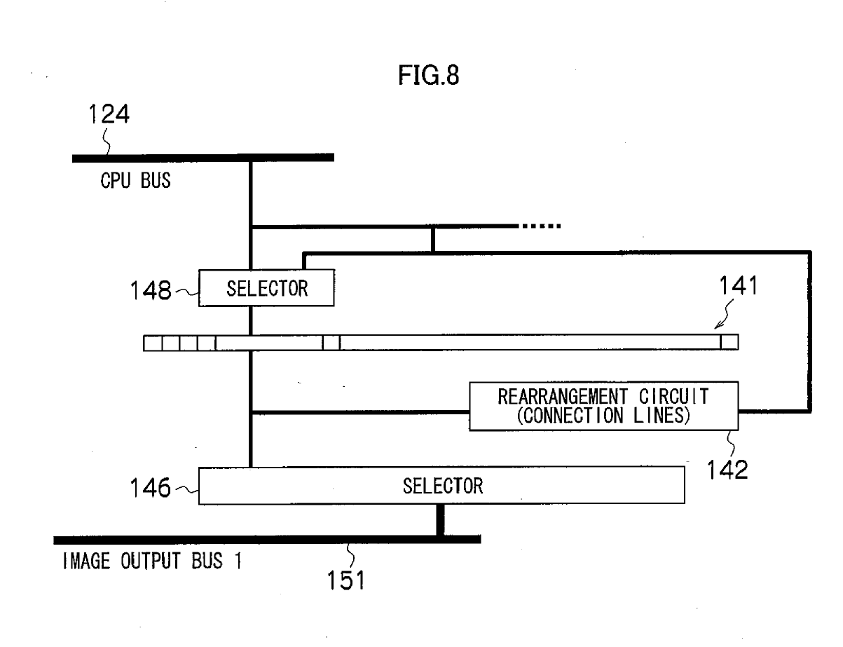

FIG. 8 shows a further structural example of the rearrangement unit 116. In FIG. 8, elements which are the same as or similar to the composition in FIG. 7 are labeled with the same reference numerals and description thereof is omitted here.

The example in FIG. 7 shows a composition having two line memories (140 and 144), one on the input side and one on the output side, but if the registers are one which permits high-speed access, then it is also possible to adopt a composition based on one line memory only, by switching the input to the register and utilizing the connections (connection lines) between the output and the input sides (see FIG. 8).

FIG. 8 is an example in which the rearrangement unit 116 is constituted by one line memory. The selector 148 shown in FIG. 8 is a device which switches the input to the line memory 141. By means of this selector 148, it is possible to switch selectively between a connection mode in which data is input from the CPU bus 124 to the line memory 141 and a connection mode in which the output from the rearrangement circuit 142 is input to the line memory 141.

When the data for one line is written to the line memory 141 via the CPU bus 124, then the output of that line memory 141 is rearranged by the rearrangement circuit 142 (connection lines). The data thus rearranged is input to the line memory 141 via the selector 148, and is stored in the line memory 141.

The rearranged data for one line thus obtained (the data stored anew in the line memory 141) is transferred to the image buffer memory 118 via the selector 146 and the first image output bus 151 (see FIG. 6).

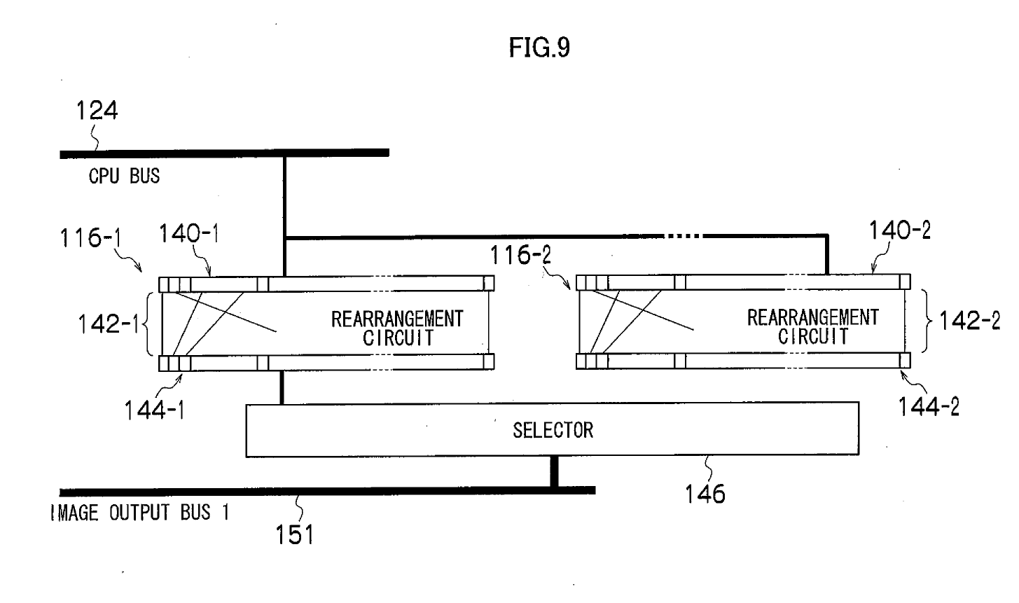

FIG. 9 shows yet a further structural example of the rearrangement unit 116. The mode shown in FIG. 9 has a composition which uses four line memories (in two sets); in other words, it comprises two sets of a rearrangement processing composition and each set has two line memories, one on the input side and one on the output side as shown in FIG. 7. In FIG. 9, parts which are the same as or similar to the composition shown in FIG. 7 are labeled with the same reference numerals and description thereof is omitted here.

In FIG. 9, a first rearrangement unit 116-1 constituted by an input-side line memory 140-1, a rearrangement circuit 142-1, and an output-side line memory 144-1, and a second rearrangement unit 116-2 constituted by an input-side line memory 140-2, a rearrangement circuit 142-2 and an output-side line memory 144-2, are provided, and by using these two rearrangement units 116-1 and 116-2 in alternating fashion, it is possible to increase the speed of the rearrangement processing for each line.

Furthermore, by adopting a composition such as that shown in FIG. 9, it is possible to use a relatively slower register, instead of the mode which uses a high-speed register as shown in FIG. 8. Of course, if the composition of the four line memories (of two sets) as shown in FIG. 9 is developed further to create a composition of multiple sets (three or more sets), then it is possible to achieve even higher speed.

Next, the processing by the rearrangement unit 116 and the writing to and the reading from the image buffer memory 118 will be described more specifically. Here, in order to simplify the explanation, the transfer of the image data (print data) shown in FIG. 10, where one word is taken as a unit of 4 bits, is described.

FIG. 10 represents print data for one page, and the region enclosed by the dotted line 170 in FIG. 10 represents the surface area region occupied by the matrix type head. Furthermore, the positions of the cells represented by the numbers 1 to 24 in FIG. 10 correspond to the numbers i=1 to 24 of the nozzle positions in the matrix type head.

The print data for one page (one sheet) of the image to be printed (FIG. 10) is stored in the image page memory 114 shown in FIG. 6, and the data is read out from this image page memory 114 by one line at a time in terms of the lines of pixel rows arranged in the main scanning direction (the lateral direction in FIG. 10), and the data for one line is transferred to the input-side line memory 140 of the rearrangement unit 116.

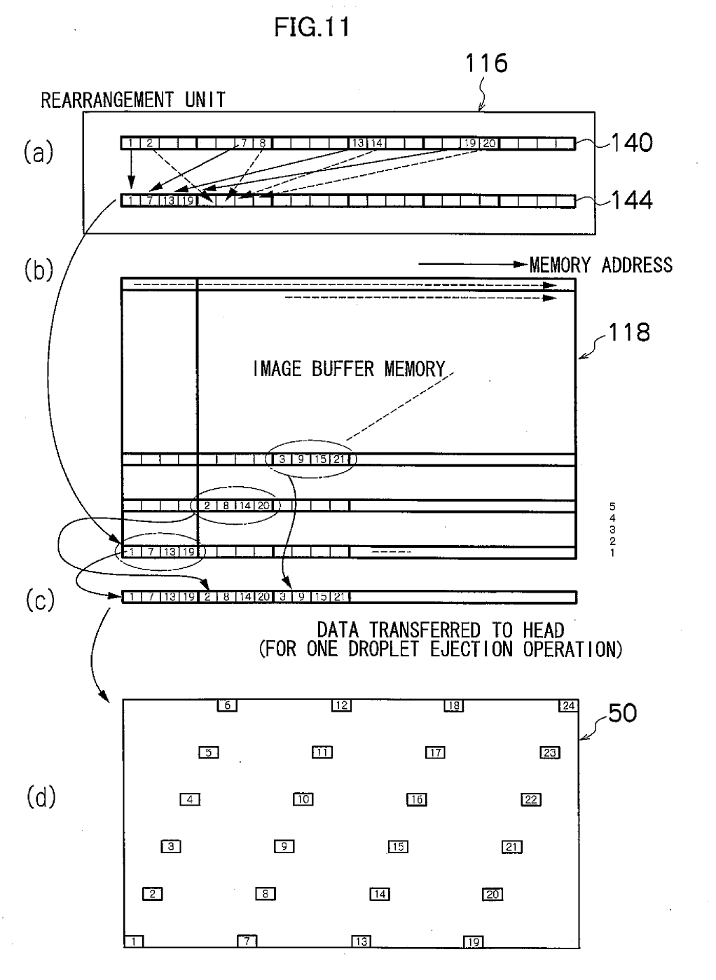

“(a)” part of FIG. 11 shows a state where the data for one line of the row number indicated by the reference symbol “k” in FIG. 10 is stored in the input-side line memory 140. Of this data for one line, the positions of the data corresponding to the adjacent nozzles 1, 7, 13, 19 which are mutually adjacent in the main scanning direction in the head are assigned with the numbers 1, 7, 13 and 19 in the FIG. 11. The data corresponding to these adjacent nozzles 1, 7, 13, 19 is located in discrete positions on one line, and the data is rearranged by the rearrangement unit 116 in such a manner that these data are positioned within the same word (in this case, a 4-bit unit).

In other words, when the data sequence on side of the input line memory 140 is taken to be {a1, a2, a3, . . . , ax} (where x=1 to 24), then on the output side after rearrangement, the data is rearranged into a data sequence in the order: {a1, a7, a13, a19, a2, a8, a14, a20, a3, a9, a15, a21, . . . }, and this data sequence after rearrangement is stored in the output-side line memory 144.

In so doing, the data of the adjacent nozzles 1, 7, 13, 19 which are mutually adjacent in the main scanning direction in the head are rearranged into data which is consecutive within one word, and the data sequences {a1, a7, a13, a19}, {a2, a8, 14, a20}, and so on formed by dividing the data up into units of 4 bits (1 word) from the initial position of the output-side line memory 144 (the left-hand end in FIG. 11), correspond to the mutually adjacent nozzles which are aligned in the main scanning direction in the head.

In order to simplify the illustration, here, the number of nozzles aligned in the main scanning direction in the matrix type head is taken to be four (for example, nozzle numbers 1, 7, 13, 19), and therefore the data corresponding to these nozzles is disposed within the same word, but in the composition of an actual apparatus which has a greater number of nozzles, the data corresponding to the respective nozzles is stored at consecutive addresses spanning a plurality of words, and therefore the data corresponding to mutually adjacent nozzles arranged in alignment in the main scanning direction is either located within the same word or is located within adjacent words.

Rearrangement processing is carried out for each line as described above, in respect of the data sequences of the other row numbers in the print data shown in FIG. 10, and as shown in “(b)” part of FIG. 11, the print data (after rearrangement) for a plurality of lines (corresponding to the surface area of the head) is stored in the image buffer memory 118.

Thereupon, the data corresponding to the print data for one droplet ejection operation (one discharge operation) of the matrix type head (for all of the nozzles 1 to 24) is read out from the image buffer memory 118 (“(c)” part of FIG. 11), and is transferred to the matrix head (“(d)” part of FIG. 11), where the ejection driving of the nozzles 1 to 24 is controlled.

In the case shown in FIG. 1, the droplet ejection data for the first ejection operation is gathered, in word (4-bit) units, respectively, from the first row (the bottommost row in “(b)” part of FIG. 11), the fifth row, the ninth row, the thirteenth row, the seventeenth row and the twenty-first row of the image buffer memory 118. The data is read out from the image buffer memory 118 in word units in this way, but since the data for adjacent nozzles which are mutually adjacent in the main scanning direction in the head is arranged consecutively within the same word, then it is possible to transfer the droplet ejection data for one ejection operation, quickly.

The droplet ejection data for the second ejection operation is gathered in word units, respectively, from the second row, the sixth row, the tenth row, the fourteenth row, the eighteenth row, and the twenty-second row of the image buffer memory 118. Thereupon, similarly, the data for one droplet ejection operation is read out from the image buffer memory 118 and is transferred sequentially to the head.

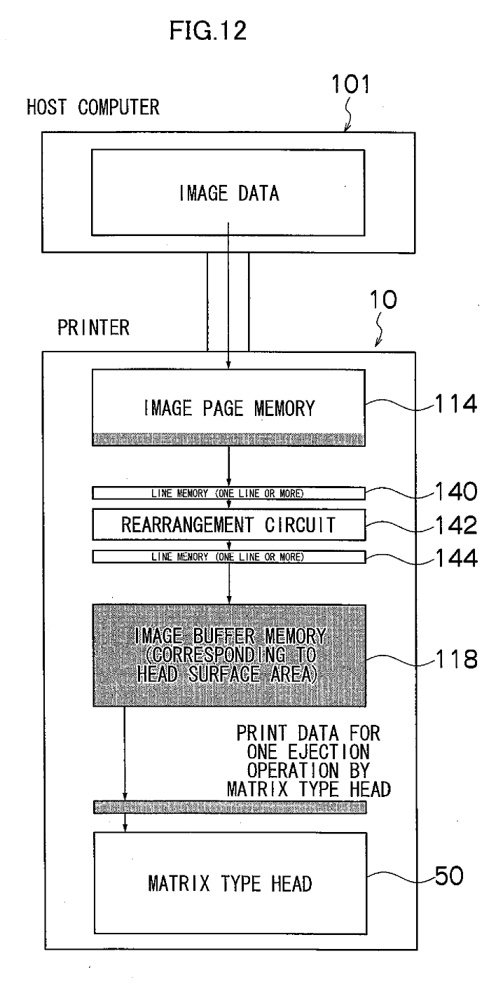

Next, the operation of the inkjet recording apparatus 10 according to the present example which has the composition described above will be explained with reference to the flow of data during printing. FIG. 12 is a schematic diagram showing the flow of image data.

Here, the inkjet recording apparatus 10 (hereinafter, referred to in some cases as the “printer”) comprises an image page memory 114 in the inkjet recording apparatus 10, and the image data for one page is transferred to the printer from the host computer 101 via a prescribed communications interface (USB or IEEE 1394, or the like). Furthermore, the composition shown as an example in FIG. 7 is adopted for the rearrangement processing unit.

### Step 1

Firstly, the image data for one page that is to be printed is stored in the image page memory 114. In this case, if the input image has multiple graduated tones, then a so-called binarization process is carried out, such as error diffusion processing, blue noise mask processing, or the like, to convert the data to data of approximately 1 bit to 2 bits per pixel, and the converted data is stored in the image page memory 114. This conversion processing is generally performed by the host computer 101, but it may also be performed by the CPU 112 inside the printer.

### Step 2

Thereupon, the print data in the image page memory 114 is transferred, one line in the main scanning direction at a time, to the input-side line memory 140 of the rearrangement unit 116. In this case, the transfer is carried out in word units of the image page memory 114 (in the present embodiment, in 32-bit widths).

### Step 3

The data in the input-side line memory 140 is rearranged by the rearrangement circuit 142 and is then written to the output-side line memory 144. This rearrangement processing is carried out in such a manner that the data for adjacent nozzles (nozzles which are aligned in the main scanning direction) in the matrix head is located within the same word or within adjacent words.

### Step 4

The data is transferred from the output-side line memory 144 to the image buffer memory 118. In this case, the data for one line thus transferred is stored at consecutive addresses in the image buffer memory 118.

### Step 5

The print data for one droplet ejection action is read out from the image buffer memory 118, and is transferred to the head 50 via the serial conversion unit 122. When reading out data from the image buffer memory 118, unlike the writing operation, the data is not read out entirely from consecutive addresses, but since the data is collected into word units, then it is possible to access the data consecutively in word units. Furthermore, rather than adopting a special composition for the memory, it is possible to compose the memory readily by using a general DRAM which is based on 32-bit units, for example.

It is also possible to process the print data in the image buffer memory 118, by means of the post-processing calculation unit 120 (see FIG. 6), between the storage of the data in the image buffer memory 118 and the transfer of the data to the head 50. As described previously, since the data for a plurality of printing operations is stored in the image buffer memory 118, and since the addresses on the image buffer memory 118 correspond with the positions of the nozzles 51 in the head 50, then a merit is obtained in that post-processing can be carried out easily (and quickly) in respect of print data corresponding to a nozzle for which processing would be complicated at the image data stage.

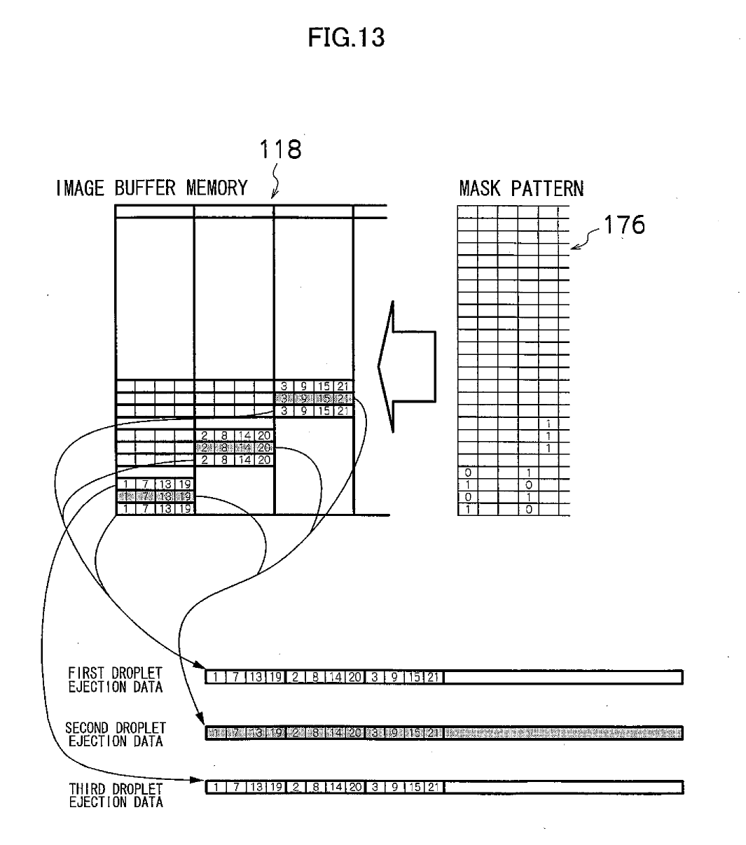

One example of processing in the post-processing calculation unit 120 is the example of a masking process in the image buffer memory 118 which is shown in FIG. 13. FIG. 13 is an illustrative diagram showing one example of the post-processing calculation unit 120.

The print data for a plurality of droplet ejection operations is stored on the image buffer memory 118 in a format where the nozzle positions of the head correspond with the memory addresses. Therefore, as shown by the example in FIG. 13, it is possible to control the data of specific nozzles by applying an AND operation on the image buffer memory 118 using the mask pattern 176.

In this example, the mask pattern 176 used is one in which the values “1 (ON)” and “0 (OFF)” are assigned alternately to the positions corresponding to the nozzle numbers “1” and “19”, and ejection is compulsorily switched to OFF for every other droplet ejection operation, in respect of the nozzle numbers “1” and “19”.

As described above, according to the present embodiment, it is possible to make data reading from the image page memory more efficient. More specifically, since there are no bits which are discarded within a word and since the data is read out from consecutive addresses, then data read-out and transfer is efficient (fast) and a composition based on an inexpensive DRAM can be used.

Furthermore, high-speed access is required only for the several line memories which have several lines and are used for the rearrangement processing, and for other processing, it is sufficient to use a buffer memory made of an inexpensive DRAM. Therefore, high-speed data transfer can be achieved readily even in the case of a matrix type head.

Moreover, in the present embodiment, since the read-out of data from the image page memory is carried out in units of print lines and this data read-out is efficient, then instead of the embodiment described above, it is also possible to adopt a composition in which an image page memory is provided in the host computer and the data is transferred to the printer by reading out data from that image page memory. In this case, it is possible to omit the image page memory inside the printer.

### Further Embodiment

The compositions shown in FIG. 6 to FIG. 12 comprise an image page memory 114 provided inside the printer. When handling images of high resolution, this image page memory 114 becomes extremely large in volume. For example, in the case of a system which reproduces images of 1200×1200 dpi resolution in six colors and four tones for each color, it is expected that a memory of 200 MB capacity will be required.

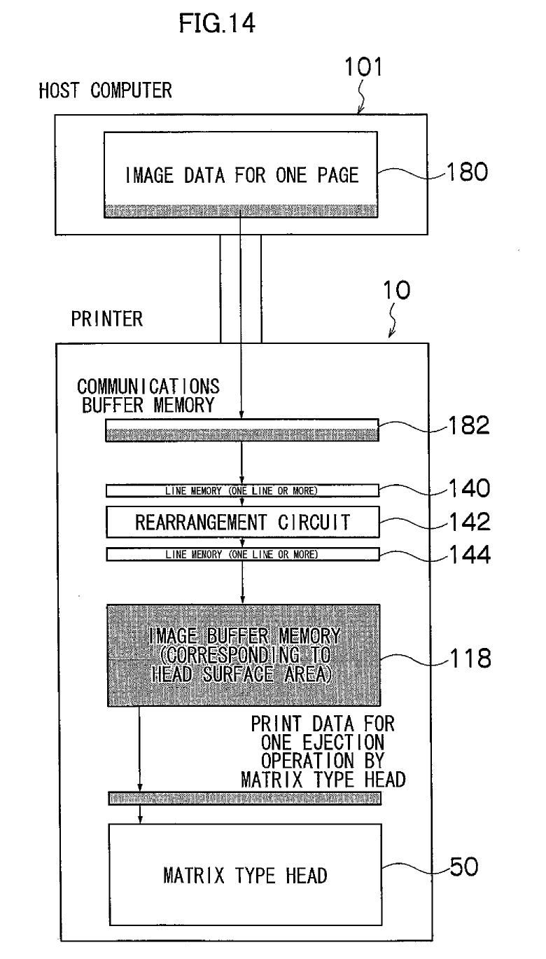

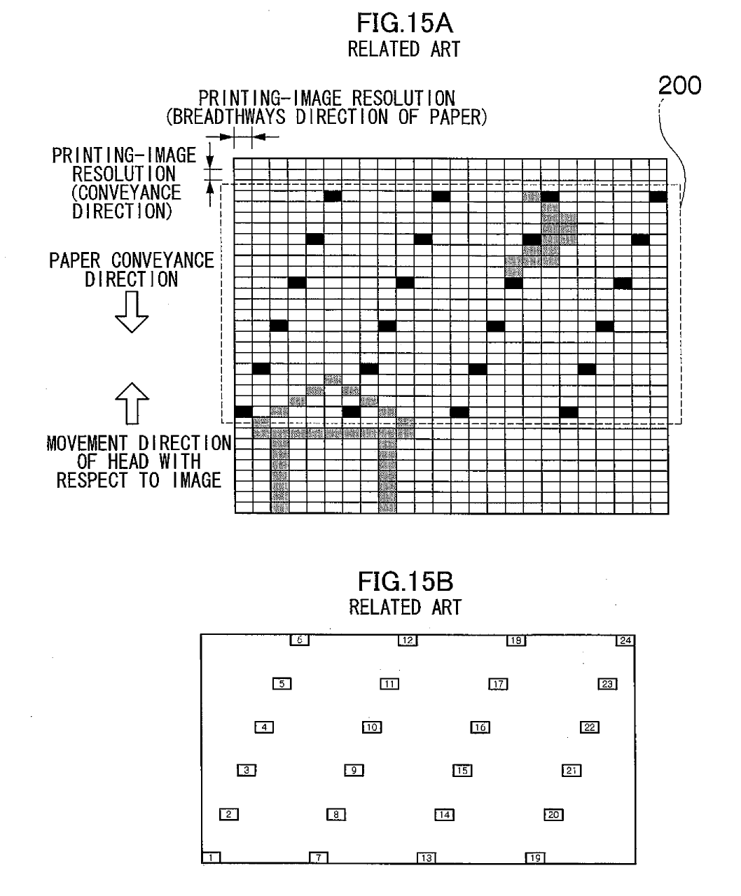

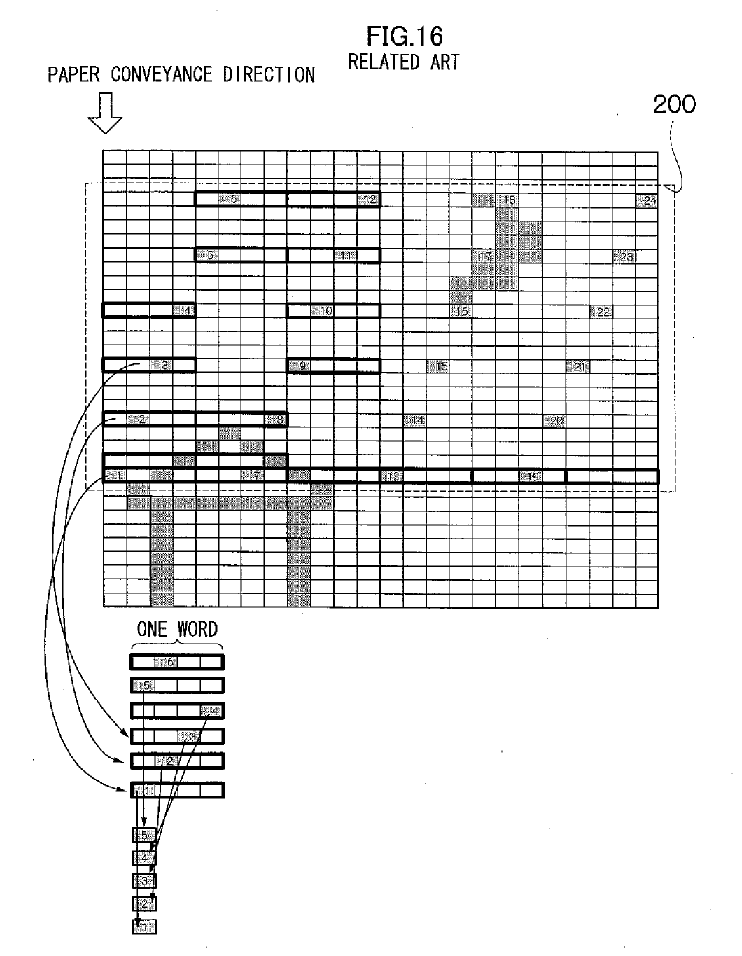

On the other hand, it is also possible to adopt a composition in which an image page memory is not provided inside the printer, as shown in FIG. 14. More specifically, in the composition shown in FIG. 14, the image data (print data) is transferred to the printer, one line at a time, from a page memory 180 inside the host computer 101. In FIG. 14, elements which are the same as or similar to those of the composition shown in FIG. 12 are labeled with the same reference numerals and description thereof is omitted here.

In the case of the composition shown in FIG. 14, a communications buffer memory 182 is provided, instead of the image page memory, on the printer side in order to compensate delay in the communications processing of the communications interface, and other such factors. This communications buffer memory 182 need to have a capacity of only several tens of lines, and therefore is required to be of only approximately 1/100^{th} the size of the page memory.

Furthermore, in the host computer 101, since the image data in the image page memory 180 is transferred to the printer, successively from the end, one line at a time, then the processing load in the host computer is also low and high-speed transfer can be achieved readily.

Embodiments of the present invention have been described above with respect to the example of an inkjet recording apparatus using a full line recording head, but the range of application of the present invention is not limited to these, and the present invention can also be applied to a case where image formation is carried out by using a short head having a nozzle row of a length which does not reach the full width of the recording medium, and performing scanning a plurality of times. The present invention is particularly beneficial when applied to a so-called single-pass image formation method, in which image recording is completed in the region of relative movement (scanning range) covered by the nozzle rows (recording element rows) of the recording head, by carrying out one relative movement of the recording head and the recording medium.

Furthermore, in the foregoing embodiments, an inkjet recording apparatus is described as one example of an image forming apparatus, but the range of application of the present invention is not limited to this. The present invention can also be applied to image forming apparatuses based on various types of methods other than an inkjet method, such as a thermal transfer recording apparatus using a line head (an apparatus using thermal elements as recording elements), an LED electrophotographic printer, a silver halide photographic type printer having an LED line exposure head (an apparatus using LED elements as recording elements), and the like.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus comprising:
a recording head including a plurality of recording elements which are arranged in a two-dimensional matrix configuration and are driven in accordance with print data while a recording medium is moved relatively with respect to the recording head in a first direction so that dots are recorded onto the recording medium to form an image on the recording medium;
a line memory which stores the print data for one line aligned in a second direction that is perpendicular to the first direction, of the print data for one page;
a rearrangement device which rearranges alignment sequence of the print data for one line stored in the line memory;
an image buffer memory which stores the print data which has been rearranged by the rearrangement device; and
a transfer device which reads out the print data from the image buffer memory and transfers the print data read out from the image buffer memory to the recording head,
wherein the rearrangement device has a configuration whereby the print data is rearranged in such a manner that data of pixels corresponding to mutually adjacent recording elements which are aligned on a straight line in the second direction in the recording head is located within a same word or within adjacent words, and
the image buffer memory has at the least a storage capacity of storing the print data rearranged by the rearrangement device for an image region corresponding to a surface area occupied by the plurality of recording elements arranged in the two-dimensional matrix configuration in the recording head.

2. The image forming apparatus as defined in claim 1, wherein the image buffer memory is constituted by a dynamic random-access memory.

3. The image forming apparatus as defined in claim 1, further comprising a post-processing calculation device of carrying out correctional processing of the print data in the image buffer memory.

4. The image forming apparatus as defined in claim 3, wherein the correctional processing is a masking process which prohibits recording of a dot onto the recording medium by a specific recording element of the recording elements.

5. A method of transferring print data in an image forming apparatus which has a recording head including a plurality of recording elements which are arranged in a two-dimensional matrix configuration and are driven in accordance with print data while a recording medium is moved relatively with respect to the recording head in a first direction so that dots are recorded onto the recording medium to form an image on the recording medium, the method of transferring print data comprising:
a line memory storing step of storing, in a line memory, the print data for one line aligned in a second direction that is perpendicular to the first direction, of the print data for one page;
a rearrangement step of rearranging alignment sequence of the print data for one line stored in the line memory;
a buffer memory storage step of storing, in an image buffer memory, the print data which has been rearranged in the rearrangement step; and
a transfer step of reading out the print data from the image buffer memory and transferring the read-out print data to the recording head,
wherein in the rearrangement step, the print data is rearranged in such a manner that data of pixels corresponding to mutually adjacent recording elements which are aligned on a straight line along the second direction in the recording head is located within a same word or within adjacent words, and
the image buffer memory has at the least a storage capacity of storing the rearranged print data for an image region corresponding to a surface area occupied by the plurality of recording elements arranged in the two-dimensional matrix configuration in the recording head.
